(19) United States
(12) Patent Application Publication
(10) Pub. No.: US 2015/0053758 A1
(43) Pub. Date: Feb. 26, 2015

(54) FIBER MANAGEMENT SYSTEM AND METHOD THEREOF

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZONG-YUAN SUN, New Taipei (TW); DA-HUA XIAO, Shenzhen (CN)

(21) Appl. No.: 14/467,611

(22) Filed: Aug. 25, 2014

(30) Foreign Application Priority Data
Aug. 26, 2013 (CN) 2013103740910

(51) Int. Cl. H04B 10/079; H04B 10/40; G06K 7/10

(52) U.S. Cl. CPC H04B 10/079; G06K 7/10366; H04B 10/40
USPC 235/375

(57) ABSTRACT

A fiber management system is for managing malfunction fiber network devices in a room, each fiber network device includes a radio frequency identification (RFID) tag. The fiber management system includes an electronic terminal, a data center, and a reader. The data center stores room information and fiber network device information in the room and transmits the stored information to the electronic terminal. The reader reads information from the RFID tags and transmits the read information to the electronic terminal. The reader includes an indicator. The electronic terminal matches the information read by the reader with the information stored by the data center and generates a controlling signal according to a matching result, the electronic terminal transmits the controlling signal to the reader, the indicator emits different colors according to different matching results. A fiber management method of the file searching device is also provided.

### CROSS-REFERENCE TO RELATED APPLICATIONS

The present application is related to the co-pending U.S. Patent Application (Attorney Docket No. US52585), entitled “READER FOR FIBER ROUTER”. This application has the same assignee as the present application and has been concurrently filed herewith. The above-identified application is incorporated herein by reference.

### FIELD

The present disclosure relates to fiber management systems, and particularly relates to a fiber management system having radio frequency identification utility.

### BACKGROUND

Optical Distribution Network (ODN) is used in Fiber to the x (FTTx) technic of telecommunication. Due to the ODN is a one-to-many standard, in one optical network connection spot can be coupled by multiple branch circuitries for transceiving network signals. There is a paper tag pasted on one branch circuitry for being identified. However, it's difficult for staff to manage multiple branch circuitries, especially when searching, inventorying, and maintaining are needed. Therefore staff may spend a great time may on daily management and has a low working efficiency.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is a functional block of an exemplary embodiment of a fiber management system.

FIG. 2 is a flowchart of a fiber management method of the fiber management system of FIG. 1.

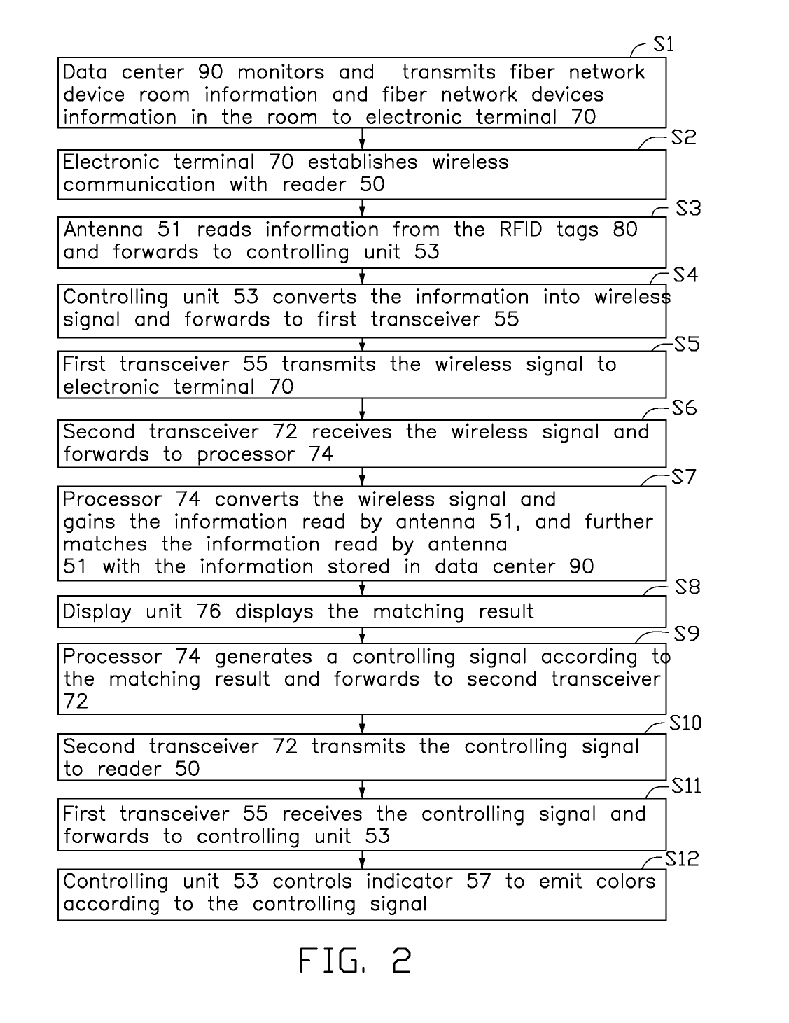

### DETAILED DESCRIPTION

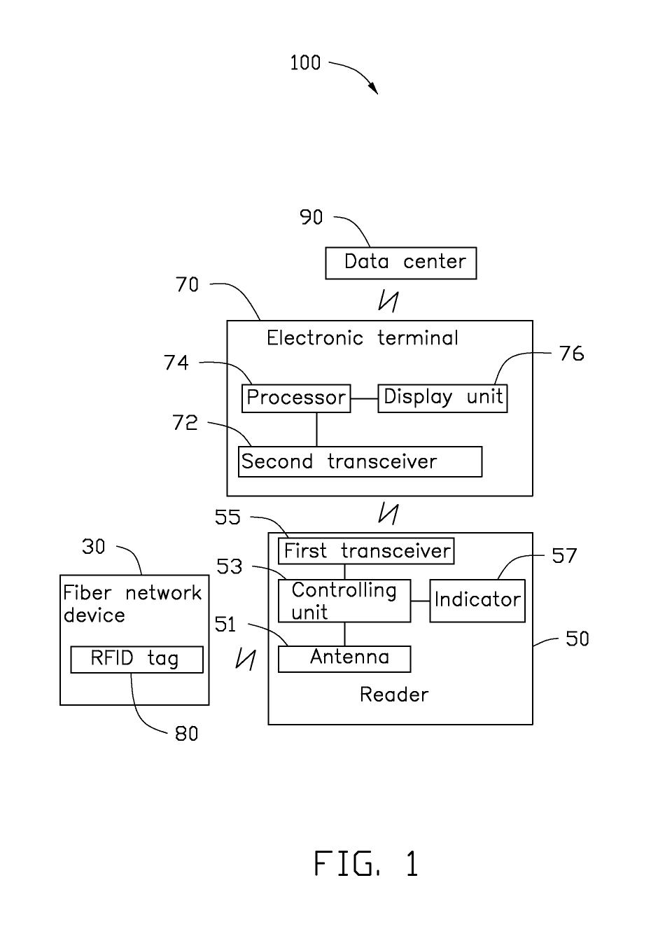

FIG. 1 illustrates at least one embodiment of a fiber management system 100. The fiber management system 100 is for managing fiber network devices 30 with radio frequency identification (RFID) tags 80.

The fiber management system 100 includes a reader 50, an electronic terminal 70, and a data center 90. The data center 90 can be a fiber network centre which stores fiber network user information and fiber network devices' 30 room information of a district. When a user finds out there is a malfunction fiber network accrued, maintenance staffs can check the user's information, corresponding fiber network devices' 30 room information, and fiber network devices' 30 information in the room in the data center 90, and find out an exact malfunction fiber network device 30 using the reader 50 and the electronic terminal 70.

The data center 90 establishes wirelessly communication with the electronic terminal 70 and transmits wireless signals to the electronic terminal 70. The wireless signals include location information of the room storing the malfunction fiber device and all fiber network devices' 30 information in the room. The reader 50 establishes wirelessly communication with the electronic terminal 70. The reader 50 reads information from the RFID tags 80 of the fiber network devices 30 and forwards the information to the electronic terminal 70. The electronic terminal 70 receives the information from the reader 50 and feeds back a control signal to the reader 50. The reader 50 can help the staff find out the malfunction fiber network device 30 according to the control signal.

The reader 50 includes an antenna 51, a controlling unit 53, a first transceiver 55, and an indicator 57. The antenna 51, the first transceiver 55, and the indicator 57 are electrically connected to the controlling unit 53.

The antenna 51 reads information from the RFID tags 80 of the fiber network devices 30 and forwards the information to the controlling unit 53. The controlling unit 53 processes the information and transfers to the first transceiver 55. The first transceiver 55 transmits the information to the electronic terminal 70 and receives the control signal from the electronic terminal 70, and then forwards the control signal the controlling unit 53. The first transceiver 55 can be a Bluetooth module, an infrared module, or a WI-FI module. The indicator 57 can be a Light-Emitting Diode (LED) or a buzzer. In one embodiment, the indicator 57 is an LED and corresponds to the antenna 51. The controlling unit 53 controls the indicator 57 to emit colors according to the control signal after receiving the control signal from the electronic terminal 70. In one embodiment, the indicator 57 can emit red or green to differentiate the malfunction fiber network device 30 from other normal fiber network devices 30.

In other embodiments, the indicator 57 can emit other colors, just for indicating different colors between the normal fiber network device 30 and the malfunction fiber network device 30. There can be a plurality of antenna 51 and a plurality of indicators 57, each indicator 57 corresponds to one antenna 51 and shows a reading result of the corresponding antenna 51.

The electronic terminal 70 can be a portable data processing device, such as a personal digital assistant (PDA) and a tablet computer.

The electronic terminal 70 includes a second transceiver 72, a processer 74, and a display unit 76. The second transceiver 72 and the display unit 76 are electrically connected to the processer 74. The second transceiver 72 receives the information of the RFID tags from the first transceiver 55 and forwards to the processer 74. The second transceiver 72 also receives the control signal from the processer 74 and transmits to the reader 50. The second transceiver 72 can be a Bluetooth module, an infrared module, or a WI-FI module. The processer 74 matches the information of the RFID tags 80 from the reader 50 with the data received from the data center 90, and thereby generating the control signal. The display unit 76 displays the matching result from the processer 74. In one embodiment, when the information read by the antenna 51 is matched with the information stored by the data center 90, a normal fiber network device 30 is determined being read; when the information read by the antenna 51 is not matched with the information stored by the data center 90, a malfunction fiber network device 30 is determined being read.

When the fiber management system 100 works for managing fiber network devices 30, a fiber management method includes following steps:

Step S1, the data center 90 monitors the fiber network devices 30 rooms and finds out a corresponding fiber network device 30 room when a malfunction fiber network device 30 is found, the data center 90 transmits fiber network devices 30 room information and fiber network devices 30 information in the room to the electronic terminal 70. Staff can find the exact fiber network devices 30 room according to the information received by the electronic terminal 70.

Step S2, the electronic terminal 70 establishes wireless communication with the reader 50. In one embodiment, the wireless communication can be Bluetooth, infrared, or WI-FI.

Step S3, the antenna 51 reads information from the RFID tags 80 of the fiber network devices 30 and forwards the information to the controlling unit 53.

Step S4, the controlling unit 53 converts the information into wireless signal and forwards to the first transceiver 55.

Step S5, the first transceiver 55 transmits the wireless signal to the electronic terminal 70.

Step S6, the second transceiver 72 receives the wireless signal and forwards to the processor 74.

Step S7, the processor 74 converts the wireless signal and gains the information of the RFID tags read by the antenna 51, and further matches the information read by the antenna 51 with the information of the fiber network devices 30 stored in data center 90.

Step S8, the display unit 76 displays the matching result.

Step S9, the processor 74 generates a controlling signal according to the matching result and forwards the controlling signal to the second transceiver 72.

Step S10, the second transceiver 72 transmits the controlling signal to the reader 50.

Step S11, the first transceiver 55 receives the controlling signal and forwards to the controlling unit 53.

Step S12, the controlling unit 53 controls the indicator 57 to emit colors according to the controlling signal. In one embodiment, when a normal fiber network device 30 is read, the controlling signal controls the indicator 57 to emit green; when a malfunction fiber network device 30 is read, the controlling signal controls the indicator 57 to emit red. Staff can easily find out the malfunction fiber network device 30 according to the color of the indicator 57, further repairs and maintains the malfunction fiber network device 30.

The antenna 51 of the reader 50 reads information from the RFID tags 80 of the fiber network devices 30, the reader 50 transmits the information to the electronic terminal 70, the processor 74 matches the information read by the antenna 51 with the information of the fiber network devices 30 stored by the data center 90 and further generates the controlling signal according to the matching result, the indicator 57 works with different colors according to the controlling signal. Therefore, staff easily and quickly finds out the malfunction fiber network device(s) 30, saving time and optimizing a management of the fiber router 200.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A fiber management system for managing malfunction of fiber network devices in a room, each fiber network device comprising a radio frequency identification (RFID) tag, the fiber management system comprising:
an electronic terminal;
a data center storing room information and fiber network device information and configured to transmit the stored information to the electronic terminal; and
a reader configured to read information from the RFID tags and transmit the read information to the electronic terminal, the reader comprising an indicator;
wherein the electronic terminal is configured to match the information read by the reader with the information stored by the data center and generate a controlling signal according to a matching result, transmit the controlling signal to the reader, the indicator emits different colors according to different matching results.

2. The fiber management system as claimed in claim 1, wherein the reader comprises an antenna, the antenna reads the information from the RFID tags of the fiber network devices.

3. The fiber management system as claimed in claim 2, wherein reader further comprises a controlling unit electrically connected to the antenna and the indicator, the antenna transmits the information read from the RFID tags to the controlling unit, the controlling unit converts the information into wireless signal that can be wireless transmitted to the electronic terminal, the controlling unit further controls the indicator to work according to the controlling signal.

4. The fiber management system as claimed in claim 3, wherein reader further comprises a first transceiver electrically connected to the controlling unit, the first transceiver transmits the wireless signal converted by the controlling unit to the electronic device.

5. The fiber management system as claimed in claim 4, wherein the electronic device comprises a second transceiver wirelessly communicated with the first transceiver, the second transceiver receives the wireless signal transmitted by the first transceiver.

6. The fiber management system as claimed in claim 5, wherein the electronic device further comprises a processor electrically connected to the second transceiver, the processor receives the wireless signal from the second transceiver and then gains the information of the RFID tags read by the antenna.

7. The fiber management system as claimed in claim 6, wherein the processor matches the information read by the antenna with the information stored by the data center and then generates the controlling signal, the processor forwards the controlling signal to the second transceiver.

8. The fiber management system as claimed in claim 7, wherein the electronic terminal further comprises a display unit electrically connected to the processor, the display unit displays the matching results of the processor.

9. The fiber management system as claimed in claim 7, wherein the processor transmits the controlling signal to the controlling unit via the second transceiver and the first transceiver, thereby the controlling unit controlling the indicator to emit different colors according to the controlling signal.

10. The fiber management system as claimed in claim 9, wherein when the information read by the antenna is matched with the information stored by the data center, the processor determines a normal fiber network device is read, and thereby generating the controlling signal to control the indicator to emit a color; when the information read by the antenna is not matched with the information stored by the data center, the processor determines a malfunction fiber network device is read, and thereby generating the controlling signal to control the indicator to emit another color.

11. The fiber management system as claimed in claim 9, wherein first transceiver and the second transceiver are Bluetooth, infrared, or WI-FI modules.

12. The fiber management system as claimed in claim 1, wherein the electronic terminal establishes wirelessly communication with the data center, thereby the data center transmitting location information of a room contains a malfunction fiber network device to the electronic terminal.

13. The fiber management system as claimed in claim 1, wherein the indicator is a Light-Emitting Diode.

14. A fiber management method comprising:
pre-storing information of fiber network devices of a room;
reading information from FRID tags of the fiber network devices;
matching the read information with the stored information;
generating controlling signals according to matching results;
controlling an indicator to emit different colors according to the controlling signals.

15. The fiber management method as claimed in claim 14, further comprising:
when the read information is matched with the stored information, determining a normal fiber network device is read, and thereby generating the controlling signal to control the indicator emit a color;
when the read information is not matched with the stored information, determining a malfunction fiber network device is read, and thereby generating the controlling signal to control the indicator emit another color.

16. The fiber management method as claimed in claim 15, further comprising transmitting the stored information from a data center to an electronic terminal.

17. The fiber management method as claimed in claim 16, further comprising transmitting the read information from a reader to the electronic terminal.

18. The fiber management method as claimed in claim 17, wherein the information transmission between the reader and the electronic terminal is operated by a first transceiver and a second transceiver mounted in the reader and the electronic terminal, respectively.

19. The file searching method as claimed in claim 18, wherein the indicator is mounted in the reader, the controlling signal is transmitted from the electronic terminal to the reader via the second transceiver and the first transceiver.

20. The file searching method as claimed in claim 14, further comprising displaying the matching results in a display unit.
